(19) United States
(12) Patent Application Publication
(10) Pub. No.: US 2026/0257785 A1
(43) Pub. Date: Sep. 3, 2026

(54) CUSTOMIZABLE PLINTH FOR AN AIRCRAFT

(71) Applicant: Raytheon Systems Limited, Harlow (GB)

(72) Inventors: Kevan Ellis Whittaker, Chester (GB); Paul Keith Whittle, Bickerstaffe (GB); Robert Henry Sneddon, Salford (GB); Stephen White, Bretton (GB); David Jack, Bretton (GB); Stephen Nuttall, Bretton (GB); Brian Michael Streeton, Camblesforth (GB)

(21) Appl. No.: 19/656,462

(22) Filed: Apr. 23, 2026

Related U.S. Application Data
(63) Continuation of application No. PCT/GB2024/052737, filed on Oct. 25, 2024.

(30) Foreign Application Priority Data
Oct. 26, 2023 (GB) 2316365.2

(51) Int. Cl. B64C 7/00; B64C 1/06; B64C 1/36

(52) U.S. Cl. CPC B64C 7/00; B64C 1/061; B64C 1/36

(57) ABSTRACT

A mounting structure for mounting a plinth fairing to a fuselage of an aircraft includes a plurality of lateral frames, including at least one pair of adjacent frames having a first lateral frame and a second lateral frame; and a plurality of intercostal ribs includes at least a first intercostal rib; wherein the at least one pair of adjacent lateral frames is configured to be attachable to the fuselage of the aircraft; and wherein the first intercostal rib is configured to be selectively removably attachable to the first lateral frame and the second lateral frame.

### CROSS-REFERENCE TO RELATED APPLICATIONS AND PRIORITY CLAIM

This application claims priority as a continuation of International Patent Application No. PCT/GB2024/052737 filed on October 25, 2024, which claims priority to United Kingdom Patent Application No. 2316365.2 filed on October 26, 2023. Both of these prior applications are hereby incorporated by reference in their entirety.

### TECHNICAL FIELD

There can be an operational requirement to contain equipment on an aircraft. Some aircrafts are provided with plinth structures on the outside of the fuselage in which equipment such as sensors and/or antennae can be stored. Plinth structures are typically positioned on the underside of the aircraft.

### BACKGROUND

Aircraft often house on the exterior of the aircraft various sensors, antennae, and electrical equipment for different operational roles. These sensors and equipment can be housed within a plinth. A plinth typically comprises a mounting structure onto which aerodynamic plinth fairings are mounted. The plinth is secured to the underside of the fuselage of the aircraft.

Existing plinths provide limited access to the sensors and equipment housed within the plinth. It is normally difficult to access the sensors and equipment. This results in associated difficulty in changing operational roles of the aircraft depending on the mission for which the aircraft is being used. It is also difficult to change operational roles if the plinth is only designed to accommodate a specific type of sensor.

US 2008/0246670 A1 discloses equipment directly mounted to the fuselage and protected by an external cover. US 6,094,171 A discloses a removable equipment pod for an aircraft which has an exterior conductive wall with a tapered notch for certain kinds of equipment. GB2591212 describes storing equipment in a structure comprising an irremovable mounting structure and a removable cover.

There is a need for a plinth structure for storing sensors, antennae and electrical equipment on aircraft that allows access to the equipment for maintenance and upgrading, and that provides a reconfigurable space to enable different equipment to be mounted therein so that the aircraft can be reconfigured for different missions.

### SUMMARY

The described kit for mounting a plinth fairing to a fuselage of an aircraft solves the above problems by providing a mounting structure comprising interchangeable intercostal ribs thereby allowing the mounting structure to be adapted to different equipment without requiring replacement of the entire structure. Moreover, the kit comprises a plinth fairing that can be removed and replaced in parts such that the equipment can be accessed without needing to remove the entire plinth cover.

According to a first embodiment of the invention, a mounting structure for mounting a plinth fairing to a fuselage of an aircraft is provided. The mounting structure comprises a plurality of lateral frames comprising at least one pair of adjacent frames comprising a first lateral frame and a second lateral frame. The mounting structure further comprises a plurality of intercostal ribs comprising at least a first intercostal rib. The at least one pair of adjacent lateral frames is configured to be attachable to the fuselage of the aircraft, and the first intercostal rib is configured to be selectively removably attachable to the first lateral frame and the second lateral frame. Advantageously, providing a mounting structure comprising selectively removably attachable intercostal ribs allows for removal and replacement of the intercostal ribs in the mounting structure. This removal and replacement allows for an adaptation of the mounting structure to the needs of the mission. For example, if the operator wishes to replace a sensor attached to the mounting structure with a sensor having different attachment requirements, they may replace the intercostal rib to which the old sensor was attached with a new intercostal rib corresponding to the attachment requirements of the new sensor, without needing to remove and replace the entire mounting structure. This adaptability provides the operator with increased design flexibility, as well as reducing maintenance time and costs. Furthermore, this allows for the plinth to be larger than plinths already known in the art. It is possible for the plinth of the invention to be larger because the selectively releasable nature of the intercostal ribs allows for the plinth to be maintained/altered in small sections at a time, rather than requiring the removal of the entire plinth in one go.

The plurality of lateral frames may be configured to be irremovably attachable to the fuselage. Advantageously, the provision of lateral frames that are irremovably attachable to the fuselage allows for the lateral frames to provide a permanent structure to which the intercostal ribs may be selectively removably attachable.

Each lateral frame of the plurality of lateral frames may comprise a first width, a first height extending along a yaw axis of the aircraft and a first length, wherein the first length is greater than the first width, and wherein the first length is oriented along a first direction that is either: orthogonal to the longitudinal axis of the fuselage; or along the longitudinal axis of the fuselage. An advantage associated with orientating each lateral frame orthogonally to the longitudinal axis of the fuselage is that the lateral frames may be longitudinally aligned with any fuselage frames that are also orthogonal to the longitudinal axis of the fuselage, which provides further support to the mounting structure.

Each intercostal rib of the plurality of intercostal ribs may comprise a second width, a second height extending along the yaw axis and a second length, wherein the second length is greater than the second width, and wherein the second length is oriented along a second direction that is orthogonal to the first direction, i.e. along the other orientation of: orthogonally to the longitudinal axis of the fuselage, and along the longitudinal axis of the fuselage, as compared to the orientation of each lateral frame. Advantageously, the intercostal ribs being orientated the other of orthogonally to or along the longitudinal axis of the fuselage to the plurality of lateral frames allows for the mounting structure to have a lattice-like structure. This provides square or rectangular compartments between the respective plurality of lateral frames and plurality of the intercostal ribs in which equipment can be stored once the cover has been placed on the mounting structure.

The mounting structure may further comprise a second intercostal rib of the plurality of intercostal ribs, wherein the second intercostal rib is configured to be: attachable to the first lateral frame and the second lateral frame, and spaced from the first intercostal rib along the first direction. Advantageously, the provision of first and second intercostal ribs spaced from each other along the first direction allows for the mounting structure to have a lattice-like structure. This provides several closed sub-compartments between the respective plurality of lateral frames and plurality of the intercostal ribs in which equipment can be stored once the cover has been placed on the mounting structure.

The second intercostal rib is configured to be selectively removably attachable to the first lateral frame and the second lateral frame, or the second intercostal rib is configured to be irremovably attachable to the first lateral frame and the second lateral frame. Advantageously, providing a mounting structure comprising further selectively removably attachable intercostal ribs allows for removal and replacement of the intercostal ribs in the mounting structure. This removal and replacement allows for an adaptation of the mounting structure to the needs of the operator. For example, if the operator wishes to replace a sensor attached to the mounting structure with a sensor having different attachment requirements, they may replace the respective intercostal rib to which the old sensor was attached with a new intercostal rib corresponding to the attachment requirements of the new sensor, without needing to remove and replace the entire mounting structure. This adaptability provides the operator with even more design flexibility, as well as reducing maintenance time and maintenance costs.

Each intercostal rib of the plurality of intercostal ribs may comprise means for attaching equipment to the aircraft, and optionally, the means are configured to accommodate a harness or a cable. This allows for equipment to be easily installed in the plinth and easily attached to the mounting structure using a harness or a cable. The intercostal ribs may be configured to accommodate other attachments as appropriate.

For each respective intercostal rib of the plurality of intercostal ribs, the means may comprise a plurality of apertures, and wherein the respective intercostal rib may comprise a largest face, and wherein the total surface area of the apertures of the respective intercostal rib may be greater than half of the total surface area of the largest face of the respective intercostal rib. Advantageously, the apertures take up a large portion of the surface area of the respective intercostal rib, which provides a lattice-like structure on the respective intercostal rib. Such a structure provides increased space for attachment means which allows for larger attachment means. Moreover, the reduced size of the intercostal rib surrounding each aperture allows for easier attachment, for example winding around and weaving through harnesses, cables and similar means. An intercostal rib having a first arrangement of apertures to accommodate a first type of equipment may be removed from the mounting structure and replaced with a second intercostal rib having a second, different arrangement of apertures to accommodate a second, different type of equipment.

At least one lateral frame of the plurality of lateral frames may comprise a plurality of apertures. The respective lateral frame of the plurality of lateral frames may comprise a largest face, and wherein the total surface area of the apertures of the respective lateral frame may be greater than half of the total surface area of the largest face of the respective lateral frame. At least one lateral frame of the plurality of lateral frames may be formed in the shape of a U. Advantageously, the provision of apertures in the lateral frames or the lateral frame having a U shape may allow for greater adaptability. The apertures potentially allow the lateral frames to provide attachment means for attaching equipment to the aircraft. The U shape may allow the lateral frame to fulfil its purpose of providing support to the plinth, while also creating space to accommodate larger equipment than would otherwise be able to fit in the plinth.

At least two lateral frames of the plurality of lateral frames comprise means for attaching the plinth fairing to the fuselage of the aircraft. Advantageously, the mounting structure can be used to securely attach a cover to the aircraft, allowing for the electrical equipment stored in the plinth to be protected from the elements during flight of the aircraft. The plinth fairing may be aerodynamic.

According to a second embodiment of the invention, a kit for mounting a plinth fairing to a fuselage of an aircraft is provided. The kit comprises the mounting structure of the first embodiment and a plinth fairing wherein at least a portion of the plinth fairing is configured to be selectively removably attachable to the mounting structure. Advantageously, the mounting structure can be used to securely attach a cover to the aircraft, allowing for the electrical equipment stored in the plinth to be protected from the elements during flight of the aircraft. The selectively removable attachment of the at least a portion of plinth fairing to the mounting structure allows for easy installation and removal of the plinth fairing, which allows for easy access to the equipment stored within the plinth. This ease of access results in increased efficiency of maintenance of the equipment within the plinth.

The total amount of intercostal ribs in the plurality of intercostal ribs may be greater than twice the total amount of lateral frames in the plurality of lateral frames. Advantageously, the kit is provided with an excess of intercostal ribs in comparison to the maximum number of intercostal ribs that could be attached to the provided lateral frames once the plinth is assembled. This excess of intercostal ribs provides the operator with choice as to which of the intercostal ribs to use for each mission so that the intercostal ribs can be adapted to the equipment required for the mission, for example if different ribs are provided with different equipment attachments. This also allows for replacement of any intercostal ribs should they be damaged or otherwise unsuitable.

The plinth fairing may be formed from a material that is transparent to radiofrequency energy. Advantageously, this allows sensors or equipment contained within the plinth to communicate effectively while remaining concealed.

The plinth fairing may comprise a first fairing and a second fairing, wherein the first fairing and the second fairing are configured to be attachable to at least two lateral frames of the plurality of lateral frames. A first edge of the first fairing may be configured to be secured to the first width of the first lateral frame, and a second edge of the second fairing may also be configured to be secured to the first width of the first lateral frame. The first edge may be configured to overlap the second edge when the first fairing and the second fairing are secured to the first width of the first lateral frame, and optionally, the first fairing may be configured to be secured forward of the second fairing, i.e., further towards the nose of the aircraft. Advantageously, the first edge and the second edge may overlap when the first and second fairings are secured to the mounting structure. Particularly, if the first fairing is secured forward of the second fairing, such an overlapping arrangement improves the aerodynamic properties of the plinth by creating a smooth outline. Moreover, this reduces the number of bolted attachments since the first edge and the second edge may be secured using the same bolts. The edge may be less than 5%, 3% or 2% of the total surface area of the outward face of the first or second fairing, respectively.

The first fairing may be configured to be selectively removably attachable to at least two lateral frames of the plurality of lateral frames, and, optionally, the second fairing may be configured to be irremovably attachable to at least two lateral frames of the plurality of lateral frames. The kit may further comprise means for attaching the plinth fairing to the mounting structure. Optionally, the means may comprise fasteners. Further optionally, the fasteners may comprise bolts and the plurality of lateral frames may comprise bolt holes. The selectively removable attachment of the first and/or second fairing to the at least two lateral frames of the plurality of lateral frames allows for easy installation and removal of the plinth fairing, which allows for easy access to the equipment stored within the plinth. This ease of access results in increased efficiency of maintenance of the equipment within the plinth.

The kit may further comprise at least one compartment, wherein the at least one compartment may be formed by the at least one pair of adjacent lateral frames, the first and second intercostal ribs, and the plinth fairing. Optionally, the at least one compartment comprises a plurality of sub-compartments. Advantageously, the compartment and sub-compartments may be used to store equipment, such as electrical equipment including antennae and sensors, within the plinth.

According to a third embodiment of the invention, an aircraft is provided. The aircraft comprises a fuselage comprising a plurality of fuselage frames, and the kit of the second embodiment. The mounting structure is attached to the fuselage, and the plinth fairing is attached to the mounting structure. Advantageously, this provides a plinth for storing equipment attached to an aircraft.

The aircraft may further comprise electrical equipment stored inside the at least one compartment, and optionally, the electrical equipment may comprise antennae and/or sensors. The aircraft may further comprise a conduit configured to be connected to the electrical equipment, wherein the conduit provides a connection between the at least one compartment and an interior of the fuselage of the aircraft. Advantageously, the conduit may allow the electrical equipment to communicate with the interior of the fuselage, for example by providing power or electrical signals for communication.

Each lateral frame of the plurality of lateral frames may be respectively longitudinally aligned with a fuselage frame of the plurality of fuselage frames. Advantageously, the fuselage frames may provide load bearing support to the mounting structure.

According to a fourth embodiment of the invention, a method of mounting a plinth fairing to an aircraft comprising a fuselage is provided. The method comprises providing the kit of the second embodiment, attaching the plurality of lateral frames to the fuselage, selectively removably attaching the at least one intercostal rib to the pair of adjacent lateral frames, and selectively removably attaching the at least a portion of the plinth fairing to the at least two lateral frames of the plurality of lateral frames. Advantageously, the mounting structure can be used to securely attach a cover to the aircraft, allowing for the electrical equipment stored in the plinth to be protected from the elements during flight of the aircraft. The selectively removable attachment of the at least a portion of plinth fairing to the mounting structure allows for easy installation and removal of the plinth fairing, which allows for easy access to the equipment stored within the plinth. This may also allow for customization of the plinth fairing to the needs of a sensor, for example by providing a new portion of the fairing with an optical window to accommodate an optical sensor.

The at least two lateral frames may be the pair of adjacent lateral frames, and the method may further comprise removing the at least a portion of the plinth fairing, removing the first intercostal rib of the plurality of intercostal ribs, providing a third intercostal rib of the plurality of intercostal ribs, the third intercostal rib having a different shape from the first intercostal rib, attaching the third intercostal rib to the pair of adjacent lateral frames, and selectively removably attaching the at least a portion of the plinth fairing to the pair of adjacent lateral frames. This exchange of first and third intercostal ribs provides the operator with a choice as to which intercostal ribs to use for each mission so that the intercostal ribs can be adapted to the equipment required for the mission, for example where the first and third intercostal ribs are provided with different equipment attachments. This also allows for replacement of any intercostal ribs should they be damaged or otherwise unsuitable.

The method may further comprise removing at least a portion of the plinth fairing, providing a third fairing having a different shape from the at least a portion of the plinth fairing, attaching the third fairing to the at least two lateral frames. The selectively removable attachment of the at least a portion of the plinth fairing allows for easy installation and replacement of the at least a portion of the plinth fairing with a third fairing. The third fairing may have a different shape from the at least a portion of the plinth fairing, which allows for adaptation of the plinth to accommodate different sensors that may have different proportions. This may also allow for customization of the plinth fairing to the needs of a sensor, for example by providing a third fairing with an optical window to accommodate an optical sensor.

The step of attaching the plurality of lateral frames to the fuselage may further comprise longitudinally aligning each lateral frame of the plurality of lateral frames with a respective fuselage frame of a plurality of fuselage frames, and permanently securing each lateral frame of the plurality of lateral frames to the fuselage. Advantageously, the fuselage frames may provide load bearing support to the mounting structure.

According to a fifth embodiment of the invention, a method of storing electrical equipment on an aircraft comprising a fuselage is provided. The method comprises providing the kit as described above, attaching the plurality of lateral frames to the fuselage, selectively removably attaching the at least one intercostal rib to the pair of adjacent lateral frames, placing electrical equipment in the compartment, and selectively removably attaching at least a portion of the plinth fairing to at least two lateral frames of the plurality of lateral frames. Advantageously, the compartment and sub-compartments may be used to store equipment, such as electrical equipment including antennae and sensors, within the plinth.

The method may further comprise removing at least a portion of the plinth fairing, providing a third fairing having a different shape from the at least a portion of the plinth fairing, attaching the third fairing to the at least two lateral frames. The selectively removable attachment of the at least a portion of the plinth fairing allows for easy installation and replacement of the at least a portion of the plinth fairing with a third fairing. The third fairing may have a different shape from the at least a portion of the plinth fairing, which allows for adaptation of the plinth to accommodate different sensors that may have different proportions. This may also allow for customization of the plinth fairing to the needs of a sensor, for example by providing a third fairing with an optical window to accommodate an optical sensor.

The step of attaching the plurality of lateral frames to the fuselage may further comprise longitudinally aligning each lateral frame of the plurality of lateral frames with a respective fuselage frame of a plurality of fuselage frames, and permanently securing each

lateral frame of the plurality of lateral frames to the fuselage. Advantageously, the fuselage frames may provide load bearing support to the mounting structure.

### BRIEF DESCRIPTION OF THE DRAWINGS

FIG. 1 shows a perspective view of an aircraft.

FIG. 2 shows the aircraft of FIG. 1.

FIG. 3 shows a mounting structure for a plinth of the aircraft.

FIG. 4 shows the mounting structure of FIG. 3 comprising selectively removably attachable intercostal ribs.

FIG. 5 shows a transparent view of the plinth of the aircraft.

FIG. 6 shows the plinth fairing sections.

FIG. 7A shows the overlapping joints between the plinth fairing sections.

FIG. 7B shows the compartments formed in the plinth.

### DETAILED DESCRIPTION

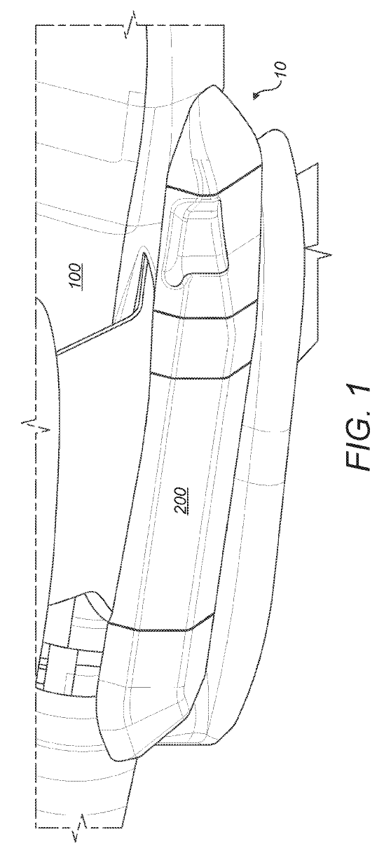

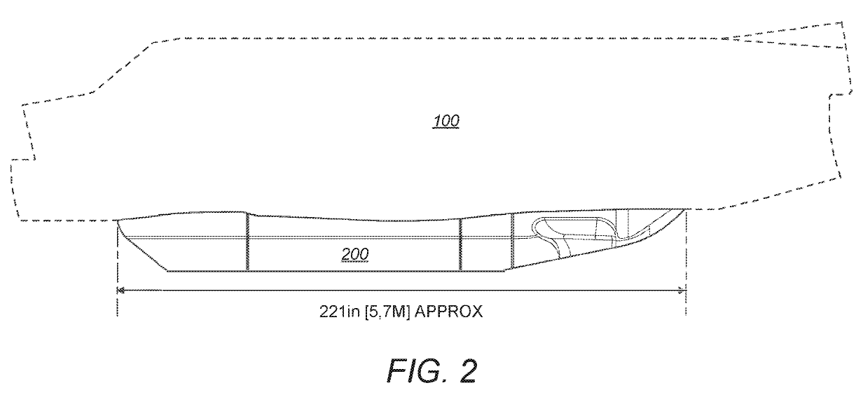

Referring to the figures, FIG. 1 shows an aircraft 10 comprising a fuselage 100. The aircraft 10 comprises a plinth 200 secured to the fuselage 100. As shown in FIG. 2, the plinth 200 has a length of approximately 5.7 m. Other suitable lengths may be used such as 5 m, 5.5 m, 6 m, 6.5 m. The length of the plinth may depend on the size of the fuselage 100 that the plinth is secured to.

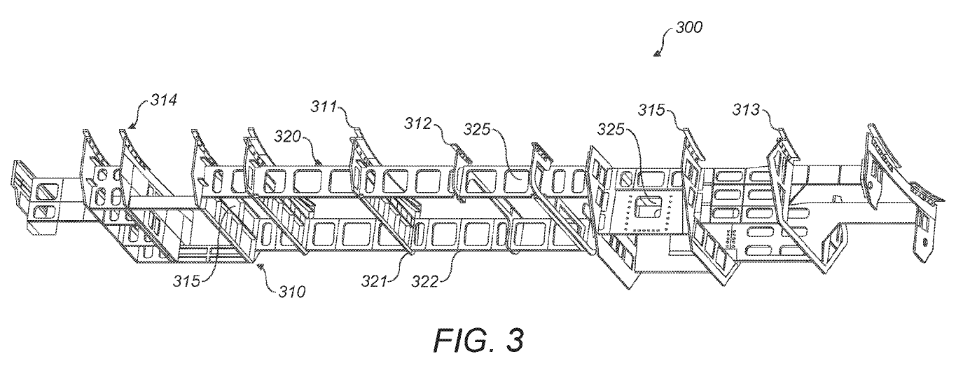

FIG. 3 shows a mounting structure 300 suitable for being positioned inside plinth 200 of FIGS. 1 and 2. The mounting structure 300 comprises a plurality of lateral frames 310. Each lateral frame of the plurality of lateral frames 310 comprises a width, a height extending along a yaw axis of the aircraft 10 and a length, wherein the length is greater than the width. The fuselage 100 comprises a longitudinal axis and the length of each lateral frame of the plurality of lateral frames 310 is orientated such that it extends orthogonally to the longitudinal axis of the aircraft 10, along the pitch axis of the aircraft 10. The fuselage may comprise a plurality of fuselage frames (not shown). Each lateral frame of the plurality of lateral frames 310 respectively may be longitudinally aligned with a respective fuselage frame of the plurality of fuselage frames. In other embodiments, the length of each lateral frame of the plurality of lateral frames 310 may extend along the longitudinal axis of the fuselage 100, in other words along the roll axis of the aircraft 10.

The plurality of lateral frames 310 may be configured to be irremovably attachable to the fuselage 100. The attachment section 314 of each frame of the plurality of lateral frames 310 may be attached to the fuselage 100 using fasteners (not shown) such as rivets or bolts. Other fasteners may be used as appropriate.

The plurality of lateral frames 310 comprises at least a first lateral frame 311, a second lateral frame 312 and a third lateral frame 313. The first lateral frame 311 is spaced from the second lateral frame 312 along the longitudinal axis of the fuselage 100, which is in turn spaced from the third lateral frame 313 along the longitudinal axis of the fuselage 100.

Each lateral frame of the plurality of lateral frames 310 comprises at least one aperture 315. The aperture 315 is suitable to accommodate means, such as cable ties or straps, for mounting equipment, such as harnesses or cables. Other means may be accommodated by the aperture 315 as appropriate. The size shape and form of the equipment may depend on the mission. The equipment may be antenna and/or sensors, or other electrical equipment.

The second lateral frame 312 has a “U”-shape. The “U”-shape allows for larger or irregularly shaped equipment to be positioned underneath the second lateral frame 312 as necessary. The third lateral frame 313 has a “U”-shape orientated in the opposite direction to the “U”-shape of the second lateral frame 312, thus allowing the third lateral frame 313 to accommodate equipment that would benefit from extending over the third lateral frame 313, for example larger or irregularly shaped equipment.

The mounting structure 300 further comprises a plurality of intercostal ribs 320. The plurality of intercostal ribs 320 comprises at least a first intercostal rib 321 and a second intercostal rib 322. Each intercostal rib of the plurality of intercostal ribs 320 is configured to be attached to the respective adjacent pair of lateral frames of the plurality of lateral frames 310. For example, intercostal rib 321 is configured to be attached to lateral frame 311 and lateral frame 312. Similarly, the second intercostal rib 322 is also configured to be attached to lateral frame 311 and lateral frame 312. The plurality of intercostal ribs 320 are attached to the fuselage 100 through their attachment to respective lateral frames of the plurality of lateral frames 310.

Each intercostal rib of the plurality of intercostal ribs 320 comprises a width, a height extending along the yaw axis of the aircraft and a length, wherein the length is greater than the width.

While each lateral frame of the plurality of lateral frames 310 is orientated such that it extends orthogonally to the longitudinal axis of the fuselage 100, the length of each corresponding intercostal rib of the plurality of intercostal ribs 320 is orientated such that it extends along the longitudinal axis of the fuselage 100. Analogously, in the alternative embodiment in which the length of each lateral frame may extend along the longitudinal axis of the fuselage 100, the length of each intercostal rib may extend orthogonally to the longitudinal axis of the fuselage 100.

Each respective intercostal rib comprises 6 faces. Each intercostal rib comprises a plurality of apertures 325. The largest faces of the intercostal ribs, those facing in the direction of orientation of the plurality of lateral frames 310, each comprise a surface area. On each of the largest faces, the total surface area of the apertures 325 of the respective intercostal rib is greater than half of the total surface area of the face. The apertures 325 may take up 60%, 70%, 80%, 90% of the total surface area of the largest faces of the intercostal rib. Therefore, the majority of the intercostal rib is taken up by the apertures 325. The apertures 325 are positioned such that they are bordered by the remaining surface area of the largest face. The apertures 325 may be suitable for accommodating means, such as cable ties or straps, for mounting equipment, such as harness or cables. Other means may be accommodated by the apertures 325 as appropriate. The equipment may depend on the mission. The equipment may be antenna and/or sensors, or other electrical equipment. The apertures 325 vary in size and shape depending on the respective intercostal rib. The apertures 325 may be square, rectangular, circular or any other appropriate shape.

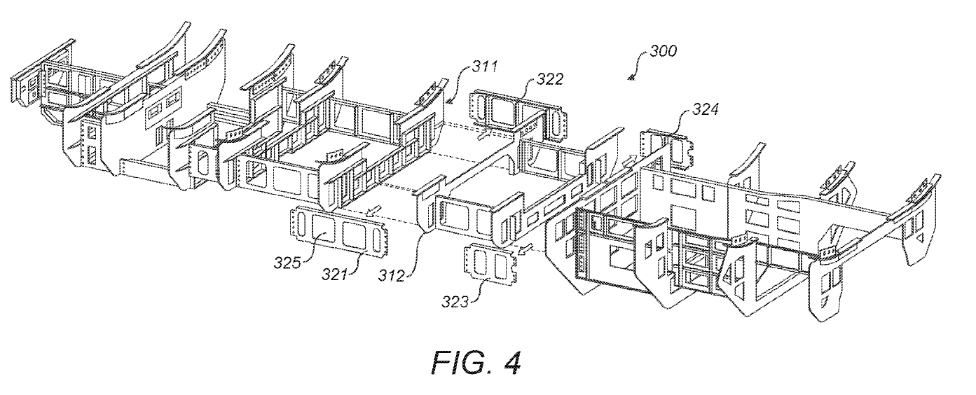

Turning to FIG. 4, intercostal ribs 321, 322, 323, and 324 are shown. Each of the intercostal ribs 321, 322, 323, and 324 is selectively removably attachable to its respective adjacent lateral frames. Intercostal rib 321 is selectively removably attachable to lateral frames 311 and 312. Intercostal rib 322 is also selectively removably attachable to lateral frames 311 and 312. As shown in FIG. 3, when the intercostal ribs 321 and 322 are attached to the lateral frames 311 and 312, the intercostal ribs 321 and 322 are spaced from each other in the direction of orientation of the respective lateral frames. Selectively removably attachable means that the intercostal rib may be attached to and removed from the respective lateral frames without damaging either the intercostal rib or the lateral frames. It is then possible to reattach the intercostal rib to the lateral frame, or to attach a different intercostal rib to the lateral frame.

Fasteners, such as bolts or other appropriate fasteners, may be used to selectively removably attach the intercostal rib to the respective lateral frames.

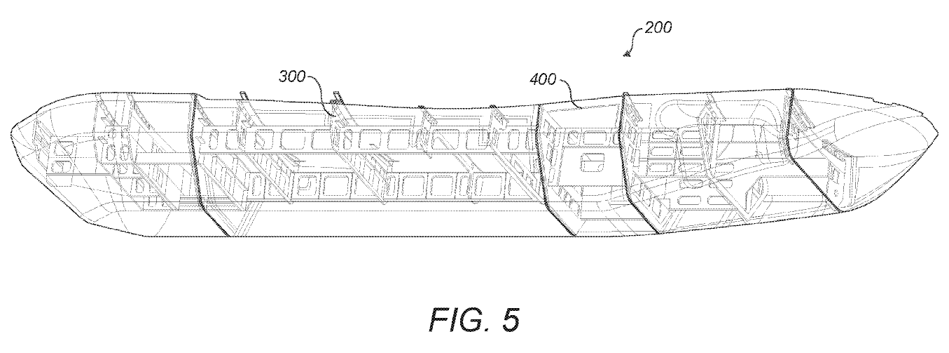

The majority of adjacent lateral frames of the plurality of lateral frames 310 have two intercostal ribs between them. However, for aerodynamic properties, the forward section of the plinth 200 is pointed, as can be seen in FIG. 1 or FIG. 5. Therefore, the two forward-most adjacent lateral frames have a single intercostal rib between them. A kit may be provided comprising a plurality of intercostal ribs 320 and a plurality of lateral frames 310, wherein a total amount of intercostal ribs in the plurality of intercostal ribs 320 is greater than twice the total amount of lateral frames in the plurality of lateral frames 310. The kit may therefore comprise an excess of intercostal ribs in comparison to the number of intercostal ribs required to assemble the mounting structure. Such an excess allows an operator to remove and replace the selectively removably attachable intercostal ribs depending on the desired attachments of the intercostal ribs or the requirements of the mission.

FIG. 5 demonstrates a transparent view of the plinth 200 comprising a plinth fairing 400 attached to the mounting structure 300. The plinth fairing 400 is attached to the plurality of lateral frames 310 of the mounting structure 300. The plinth fairing 400 may be attached to the mounting structure using bolts, rivets or other fasteners as appropriate.

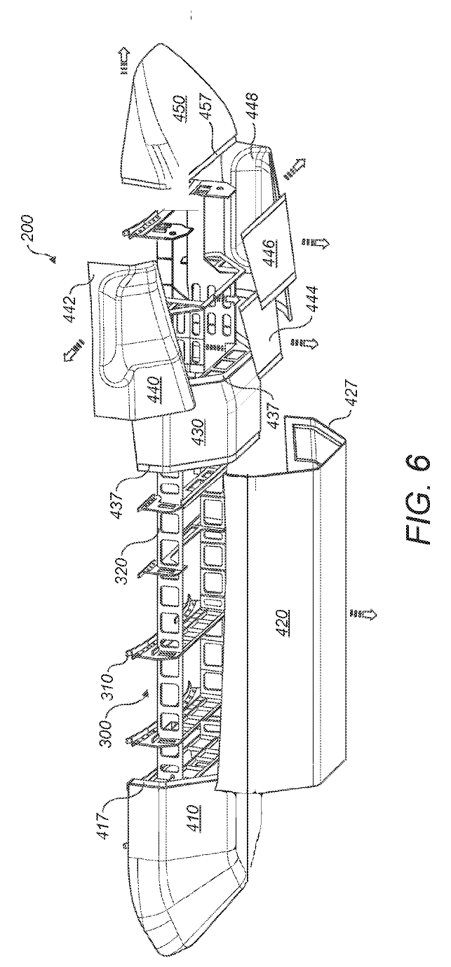

FIG. 6 shows that plinth fairing 400 comprises plinth fairing sections 410, 420, 430, 440, 450. Plinth fairing section 410 is forward of plinth fairing section 450. Plinth fairing section 440 comprises plinth fairing sub-sections 442, 444, 446, 448. Plinth fairing sections 420, 440 and 450 are selectively removably attachable to the mounting structure 300. The plinth fairing sections 420, 440 and 450 may be attached to the mounting structure using bolts or other appropriate fasteners. The plinth fairing section 440 can be removed from the mounting structure one sub-section at a time. The plinth fairing sections 410 and 430 are irremovably attachable to the mounting structure. In alternative embodiments, plinth fairing sections 410 and 430 may also be selectively removably attachable to the mounting structure. Selectively removably attachable means that the plinth fairing section or sub-section may be attached to and removed from the respective lateral frames of the mounting structure without damaging either the plinth fairing section, sub-section or the lateral frames. It is then possible to reattach the plinth fairing section or sub-section to the corresponding lateral frame, or to attach a different plinth fairing section or sub-section to the corresponding lateral frame.

Due to the selective removable attachment, the plinth fairing sections may be changed and customized to accommodate different sizes and needs of sensors or equipment housed inside the plinth. For example, any of the plinth fairing sections may be replaced with an alternative fairing that comprises an optical window to accommodate an optical sensor. Alternatively, the plinth fairing section may be transparent to radio frequency radiation to allow sensors housed inside the plinth to communicate through the plinth fairing section. The plinth fairing section 440 may also be recessed or protrude to accommodate larger or smaller equipment.

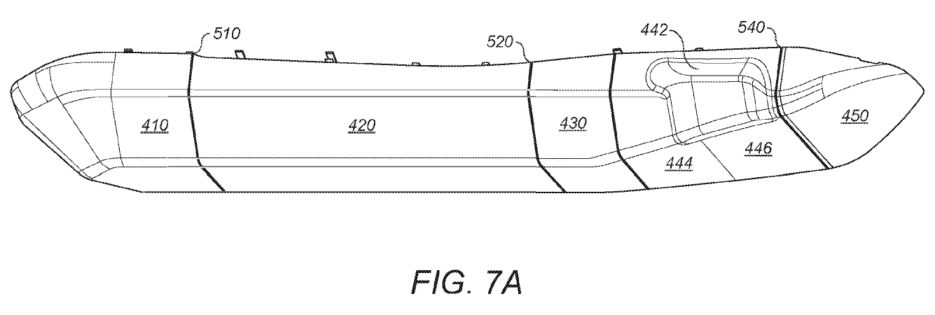

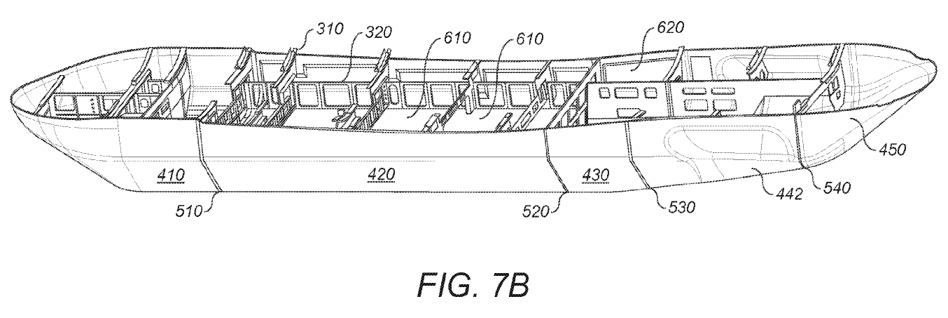

Plinth fairing section 420 comprises edge 427 (only the aft edge is shown in FIG. 6). Plinth fairing section 410 comprises edge 417 (only the aft edge is shown in FIG. 6). Plinth fairing section 430 comprises edges 437. Plinth fairing section 450 comprises edge 457. With reference to FIGS. 7A and 7B, when assembled, the forward edge 427 overlaps with aft edge 417 to form overlapping joint 510, the aft edge 427 overlaps with the forward edge 437 to form overlapping joint 520 the forward edge (not shown) of plinth fairing section 440 overlaps with aft edge 437 to form overlapping joint 530, and the aft edge (not shown) of plinth fairing section 440 overlaps with edge 457 to form overlapping joint 540. Overlapping edges provide the plinth with a smooth outer profile, and reduce the amount of bolts that are required to secure the plinth fairing 400 to the mounting structure 300 by allowing a single set of bolts to secure both overlapping edges to the width of the respective lateral frames of the mounting structure 300. The forward edges may overlap the aft edges to improve the aerodynamic properties of the plinth.

With continued reference to FIG. 7B, when assembled, the plinth fairing 400 and the mounting structure 300 form compartments 610 and sub-compartments 620. Each compartment 610 is defined by the space formed between adjacent lateral frames 310 and the respective plinth fairing section, while each sub-compartment 620 is defined by the space formed between adjacent lateral frames 310, the respective intercostal ribs 321-322 and the respective plinth fairing section. Equipment may be housed in the compartments or sub-compartments depending on the size of the equipment and the space required. A conduit may be provided in order to connect electrical equipment stored inside the compartment to the interior of the fuselage, for example by providing power or electrical signals for communication.

A method of mounting the plinth fairing 400 to the aircraft 10 may comprise providing the mounting structure 300 and the plinth fairing 400. The method may further comprise attaching the plurality of lateral frames 310 to the fuselage 100 and selectively removably attaching the intercostal ribs 320 to the adjacent lateral frames 310. The method may then comprise selectively removably attaching the plinth fairing 400 to the plurality of lateral frames 310.

A method of storing electrical equipment on an aircraft 10 may comprise providing the mounting structure 300 and the plinth fairing 400, attaching the plurality of lateral frames 310 to the fuselage 100, selectively removably attaching the intercostal ribs 320 to the adjacent lateral frames 310, placing electrical equipment in the compartment 610 and selectively removably attaching the at least a portion of the plinth fairing 400 to the plurality of lateral frames 310.

The described methods may further comprise removing a plinth fairing section, removing an intercostal rib, providing a different intercostal rib, the different intercostal rib having a different shape from the other intercostal rib, attaching the different intercostal rib to pair of adjacent lateral frames and then selectively removably attaching the plinth fairing section to the pair of adjacent lateral frames.

The described methods may further comprise removing the plinth fairing section from the pair of adjacent lateral frames, providing a different plinth fairing section having a different shape from the initial plinth fairing section, and attaching the different plinth fairing section to the pair of adjacent lateral frames.

The step of attaching the plurality of lateral frames 310 to the fuselage 100 may comprise longitudinally aligning each lateral frame of the plurality of lateral frames with a respective fuselage frame of a plurality of fuselage frames and permanently securing each lateral frame of the plurality of lateral frames 310 to the fuselage 100.

Various systems and methods for mounting equipment in a plinth on an aircraft have been described herein. Such methods and systems allow for improved customization of plinths depending on the mission.

What is claimed is:

1. A mounting structure for mounting a plinth fairing to a fuselage of an aircraft, the mounting structure comprising:
a plurality of lateral frames comprising at least one pair of adjacent lateral frames comprising a first lateral frame and a second lateral frame; and
a plurality of intercostal ribs comprising at least a first intercostal rib;
wherein the at least one pair of adjacent lateral frames is configured to be attachable to the fuselage of the aircraft; and
wherein the first intercostal rib is configured to be selectively removably attachable to the first lateral frame and the second lateral frame.

2. The mounting structure of claim 1, wherein the lateral frames are configured to be irremovably attachable to the fuselage.

3. The mounting structure of claim 1, wherein each lateral frame of the plurality of lateral frames comprises a first width, a first height extending along a yaw axis of the aircraft, and a first length, wherein the first length is greater than the first width, and wherein the first length is oriented along a first direction that is either:
orthogonal to a longitudinal axis of the fuselage, or
along the longitudinal axis of the fuselage.

4. The mounting structure of claim 3, wherein each intercostal rib of the plurality of intercostal ribs comprises a second width, a second height extending along the yaw axis, and a second length, wherein the second length is greater than the second width, and wherein the second length is oriented along a second direction that is orthogonal to the first direction.

5. The mounting structure of claim 1, wherein the plurality of intercostal ribs further comprises a second intercostal rib, and wherein the second intercostal rib is configured to be attachable to the first lateral frame and the second lateral frame and spaced from the first intercostal rib.

6. The mounting structure of claim 1, wherein each intercostal rib of the plurality of intercostal ribs comprises a coupler configured to attach equipment to the aircraft.

7. The mounting structure of claim 6, wherein each intercostal rib of the plurality of intercostal ribs comprises a plurality of apertures and a largest face, and wherein a total surface area of the apertures of each intercostal rib is greater than half of a total surface area of the largest face of the intercostal rib.

8. The mounting structure of claim 1, wherein at least one lateral frame of the plurality of lateral frames comprises a plurality of apertures.

9. The mounting structure of claim 1, wherein at least one lateral frame of the plurality of lateral frames is formed in a shape of a U.

10. The mounting structure of claim 1, wherein at least two lateral frames of the plurality of lateral frames comprise fasteners configured to attach the plinth fairing to the fuselage of the aircraft.

11. A kit comprising:
a mounting structure comprising:
a plurality of lateral frames comprising at least one pair of adjacent lateral frames comprising a first lateral frame and a second lateral frame; and
a plurality of intercostal ribs;
wherein the at least one pair of adjacent lateral frames is configured to be attachable to a fuselage of an aircraft; and
wherein at least one of the intercostal ribs is configured to be selectively removably attachable to the first lateral frame and the second lateral frame; and
a plinth fairing, wherein at least a portion of the plinth fairing is configured to be selectively removably attachable to the mounting structure.

12. The kit of claim 11, wherein a total amount of intercostal ribs in the plurality of intercostal ribs is greater than twice a total amount of lateral frames in the plurality of lateral frames.

13. The kit of claim 11, wherein the plinth fairing is formed from a material that is transparent to radiofrequency energy.

14. The kit of claim 11, wherein the plinth fairing comprises a first fairing and a second fairing, and wherein the first fairing and the second fairing are configured to be attachable to at least two lateral frames of the plurality of lateral frames.

15. The kit of claim 14, wherein a first edge of the first fairing is configured to be secured to a width of the first lateral frame, wherein a second edge of the second fairing is configured to be secured to the width of the first lateral frame, and wherein the first edge is configured to overlap the second edge when the first fairing and the second fairing are secured to the width of the first lateral frame.

16. The kit of claim 11, wherein the kit further comprises fasteners configured to attach the plinth fairing to the mounting structure.

17. The kit of claim 11, further comprising at least one compartment, wherein the at least one compartment is formed by the at least one pair of adjacent lateral frames, the intercostal ribs, and the plinth fairing.

18. An aircraft comprising:
a fuselage comprising a plurality of fuselage frames; and
the kit of claim 11;
wherein the mounting structure is attached to the fuselage; and
wherein the plinth fairing is attached to the mounting structure.

19. A method of mounting a plinth fairing to an aircraft comprising a fuselage, the method comprising:
providing the kit of claim 11;
attaching the plurality of lateral frames to the fuselage;
selectively removably attaching the at least one of the intercostal ribs to the at least one pair of adjacent lateral frames; and
selectively removably attaching the at least a portion of the plinth fairing to at least two lateral frames of the plurality of lateral frames.

20. A method of storing electrical equipment on an aircraft comprising a fuselage, the method comprising:
providing the kit of claim 11;
attaching the plurality of lateral frames to the fuselage;
selectively removably attaching the at least one of the intercostal ribs to the at least one pair of adjacent lateral frames;
placing the electrical equipment in a compartment formed by the at least one pair of adjacent lateral frames, the intercostal ribs, and the plinth fairing; and
selectively removably attaching the at least a portion of the plinth fairing to at least two lateral frames of the plurality of lateral frames.
